(19) United States
(12) Patent Application Publication
(10) Pub. No.: US 2016/0033215 A1
(43) Pub. Date: Feb. 4, 2016

(54) A purge air cyclone for use in a low frequency sound generator

(71) Applicant: INFRAFONE AB, Sundbyberg (SE)

(72) Inventors: Martin Ellebro, Skogstorp (SE); Mats Olsson, Lidingö (SE)

(21) Appl. No.: 14/781,317

(22) PCT Filed: Mar. 19, 2014
(86) PCT No.: PCT/SE2014/050330

§ 371 Date: Sep. 30, 2015

(30) Foreign Application Priority Data
Apr. 4, 2013 (SE) 1330034-8

(51) Int. Cl. F28G 7/00; B04C 9/00; B04C 5/04; B08B 7/02

(52) U.S. Cl. CPC F28G 7/00; B08B 7/026; B04C 9/00; B04C 5/04

(57) ABSTRACT

The invention relates to a purge air cyclone (20) configured to be provided on a low frequency sound generator, which comprises a compressed air supply system (9, 14), a feeder unit (1) and a resonator tube (2). The purge air cyclone may be positioned between the feeder unit and the resonator tube. The purge air cyclone comprises a short duct (21) comprising a first end (22) having a first opening (23), a second end (24) having a second opening (25) and a cavity (26). The first opening is in open communication with the feeder unit. The second opening is in open communication with the resonator tube. An inlet pipe (29) is positioned in the proximity of the first end and extends tangentially into the cavity with respect to the short duct, thereby being configured to introduce a purge air flow into the cavity so as to circulate in the cavity before leaving the cavity through the second opening.

### THE FIELD OF THE INVENTION

The present invention refers to a purge air cyclone according to the pre-characterized portion of claim 1 and a low frequency sound generator according to the pre-characterized portion of claim 9 as well as the use of said purge air cyclone for preventing dust particles entering into a cylinder of a feeder unit.

### BACKGROUND OF THE INVENTION AND PRIOR ART

The present invention relates to a low frequency sound generator, particularly a low frequency sound generator of the type described in WO2004/009255. The low frequency sound generator comprises a feeder unit and a resonator tube. The feeder unit comprises a movable piston inside a cylinder. The piston performs a reciprocating movement inside the cylinder, which is surrounded by a surge tank connected to a compressed air supply system. The piston regulates a connection opening between the interior of the cylinder and the surge tank. Since this connection opening of the cylinder is located close to an open end of the cylinder, which is facing and in communication with an opening at the rear end of the resonator tube, the gas inside the resonator tube is also in communication with the interior of the surge tank.

The dimensions of the resonator tube are chosen in such a way that a standing sound wave may be generated in the resonator tube by the compressed air supplied via the surge tank. Preferably, the resonator tube is a quarter wave resonator tube. When a standing sound wave has been generated in the resonator tube, this standing sound wave has its maximum sound pressure amplitude at the rear end where the feeder unit is situated. The sound pressure works on the end surface of the piston, resulting in a reciprocating movement of the piston. The other end of the piston is spring-loaded, and the piston can move in phase with the variations in sound pressure of the standing sound wave under the condition that the resonance frequency of the oscillating mechanical system is higher than the frequency of the standing sound wave in the resonator tube.

Low frequency sound generators of this type are, for example, used for cleaning of big boilers, heat exchangers and other apparatus with gas containing dust particles and where it is difficult to get access to the surfaces that need to be cleaned.

The set-up of a standing sound wave means that the gas inside the resonator tube is moving back and forth. As the open end of the resonator tube is in direct contact with the gas inside the boiler, containing sticky or aggressive dust particles, these dust particles can also enter into the cylinder and may build up sticky deposits on the inner surface of the cylinder and/or outer surface of the piston.

Since there is only a very small gap between the piston and the cylinder of the feeder unit, the build-up of dust particles on the inside of the cylinder in the feeder unit could be quite detrimental to the functioning of the feeder unit and cause damage to the low frequency sound generator. If there is too much of dust particles, there is even a risk that the movement of the piston is inhibited.

There is a need for a device that prevents dust particles from entering into the cylinder of the feeder unit. Preferably, the new device should not interfere with the sound waves produced by the low frequency sound generator. There is a need for a device that can be easily installed on existing low frequency sound generators.

### SUMMARY OF THE INVENTION

The object of the present invention is to provide a purge air cyclone and a low frequency sound generator that overcomes the problems mentioned above.

The object is achieved by a purge air cyclone defined in claim 1. The purge air cyclone is configured to be provided on a low frequency sound generator and configured to be positioned between the feeder unit and the resonator tube. The purge air cyclone comprises a short duct having a circular cross section, and comprising a first end, which comprises a first opening, a second end, which comprises a second opening, and a cavity defined between the first end and the second end.

The purge air cyclone of the present invention is characterized in that the first opening is configured to be in open communication with the feeder unit and the second opening is configured to be in open communication with the resonator tube, and in that an inlet pipe is positioned in the proximity of the first end and extends tangentially into the cavity with respect to the short duct, thereby being configured to introduce a purge air flow into the cavity so as to circulate in the cavity before leaving the cavity through the second opening.

The purge air cyclone can be installed on existing low frequency sound generators in an easy and cost effective manner.

In one embodiment, the inlet pipe is adapted to introduce the purge air flow for preventing of dust particles entering into the cylinder of the feeder unit.

Most of dust particles can be prevented to enter into the cylinder of the feeder unit. Thereby, the purge air cyclone prevents building up of dust deposits on the inner surface of the cylinder and the outer surface of the piston. This improves the quality as well as the durability of the feeder unit and the low frequency sound generator.

In another embodiment, the inlet pipe optionally comprises a valve configured to regulate the purge air flow through the inlet pipe.

Advantageously, the purge air flow in the purge air cyclone can be adjusted depending on the size of the cylinder and the amount of dust particles entering into the resonator tube.

In one embodiment, the compressed air supply connected to the inlet pipe is the compressed air supply system comprised to the low frequency sound generator.

The purge air cyclone can be constructed in a simple manner and installed on a low frequency sound generator in an efficient way.

In another embodiment, the short duct is configured to allow back and forth movement of the gas inside the resonator tube to pass through the first opening, the cavity and the second opening of the short duct.

An important advantage of the purge air cyclone of the present invention is that the purge air flow from the inlet pipe does not, or substantially not, interfere with the air pulses from the feeder unit. The direction of the purge air flow is unimportant in this respect.

In a further embodiment, the inlet pipe is adapted to introduce the purge air flow into the cavity without affecting the air pulses from the feeder unit.

Furthermore, the object is achieved by a low frequency sound generator initially defined and characterized in that the low frequency sound generator further comprises a purge air cyclone configured to be positioned between the feeder unit and the resonator tube, which comprises a short duct having a circular cross section, and comprising a first end, which comprises a first opening, a second end, which comprises a second opening, and a cavity defined between the first end and the second end,

whereby the first opening is configured to be in open communication with the feeder unit and the second opening is configured to be in open communication with the resonator tube, and in that
an inlet pipe is positioned in the proximity of the first end and extends tangentially into the cavity with respect to the short duct, thereby being configured to introduce a purge air flow into the cavity so as to circulate in the cavity before leaving the cavity through the second opening.

In one embodiment of the low frequency sound generator, the inlet pipe is adapted to introduce the purge air flow so as to prevent dust particles entering into the cavity of the short duct.

In another embodiment of the low frequency sound generator, the inlet pipe is connected to compressed air supply, which optionally comprises a valve configured to regulate the purge air flow through the inlet pipe.

In a further embodiment of the low frequency sound generator, the compressed air supply unit connected to the inlet pipe is the compressed air supply system comprised in the low frequency sound generator.

In one embodiment of the low frequency sound generator, the short duct is configured to allow air pulses generated by the feeder unit of the low frequency sound generator to pass through the first opening, the cavity and the second opening of the short duct.

In another embodiment of the low frequency sound generator, the inlet pipe is adapted to introduce the purge air flow into the cavity without affecting the pulses generated by the feeder unit of the low frequency sound generator.

The object is also achieved by a use of the low frequency sound generator according to any one of claims 9 to 14 for cleaning a boiler or a heat exchanger.

The advantages of the sound generator, as well as the preferred embodiments thereof, are apparent from the discussion above with reference to the purge air cyclone.

### BRIEF DESCRIPTION OF THE DRAWINGS

The present invention is now to be explained more closely by means of embodiments, which are disclosed as examples, and with reference to the attached drawings.

FIG. 1 shows schematically a feeder unit of a low frequency sound generator with the piston located at an upper dead centre.

FIG. 2 shows schematically a feeder unit of a low frequency sound generator with the piston located at a lower dead centre.

FIG. 3 shows a purge air cyclone according to an embodiment of the present invention.

### DETAILED DESCRIPTION OF VARIOUS EMBODIMENTS OF THE INVENTION

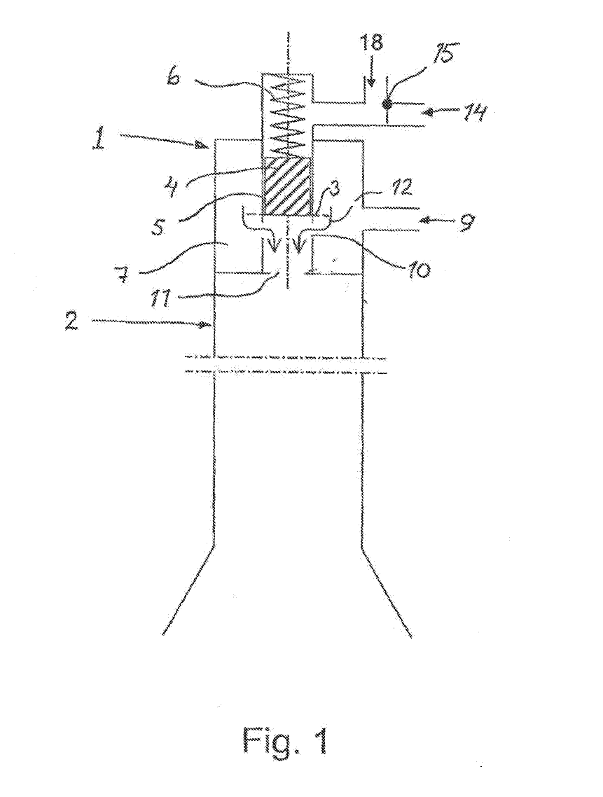

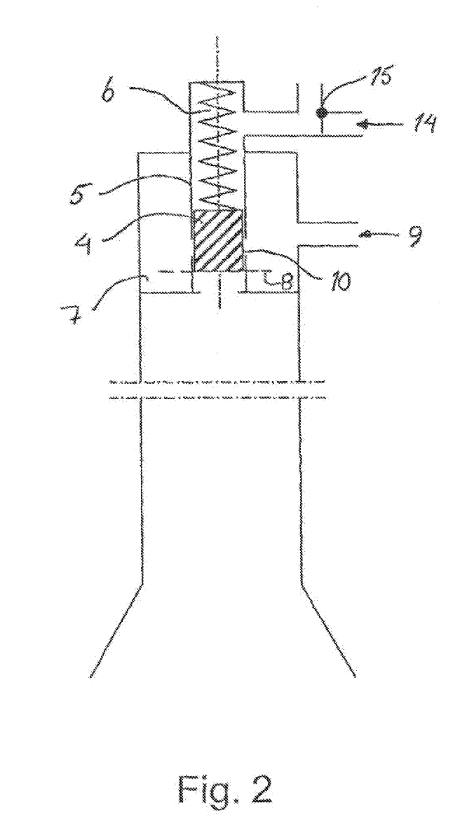

FIG. 1 shows a feeder unit 1 of a low frequency sound generator mounted on a resonator tube 2. The resonator tube may be a quarter wave resonance tube 2. The feeder unit 1 comprises a piston 4 that is arranged to perform a reciprocating movement inside a cylinder 5, between an upper dead centre 3 shown in FIG. 1, and a lower dead centre 8 shown in FIG. 2. The piston 4 is spring-loaded by means of a spring 6, which is attached to the closed end of the cylinder 5. The cylinder 5 and the piston 4 are mounted in a surge tank 7. A compressed air supply system 9, is connected to the surge tank 7. The cylinder 5 has an open end 11 facing the resonator tube 2 and communicating therewith. The cylinder 5 is also provided with one or several connection openings 10 in the cylinder wall by means of which the compressed air supplied to the surge tank 7 can enter into the cylinder 5 and continue down into the resonator tube 2. At the upper closed end of the cylinder 5, above the piston 4, there is a connection opening 18 used for pressure equalisation and it provides a communication either to atmospheric pressure or to a space at the open end of the resonator tube 2.

When the standing sound wave inside the resonator tube has its maximum sound pressure acting at the piston 4, the piston 4 is pressed to the upper dead centre 3 as shown in FIG. 1. At that position, the connection openings 10 in the cylinder 5 are open and an air pulse 12 is fed into the cylinder 5.

When the standing sound wave inside the resonator tube has its minimum sound pressure acting at the piston 4, the piston 4 is suctioned to its lower dead centre 8 as shown in FIG. 2, and the connections openings 10 are closed.

At an end of the cylinder 5, which is not facing the resonator tube 2 and at which end the spring 6 of the piston 4 is fitted, there is a second compressed air supply system 14 connected to the cylinder 5. This second compressed air supply system 14 supplies a compressed air flow, which is regulated by a regulating valve 15. The pressure of this compressed air is much higher than the pressure of the standing sound wave. As long as the regulating valve 15 is at the position shown in FIGS. 1 and 2, i.e. the supply from the compressed air supply system 14 is shut off, the piston 4 will move between the upper dead centre 3 and lower dead centre 8 with the frequency of the standing sound wave in the resonator tube 2. Further details regarding the low frequency sound generator are described on pages 2 to 4 of WO 2004/009255, which is hereby included in its entirely by reference.

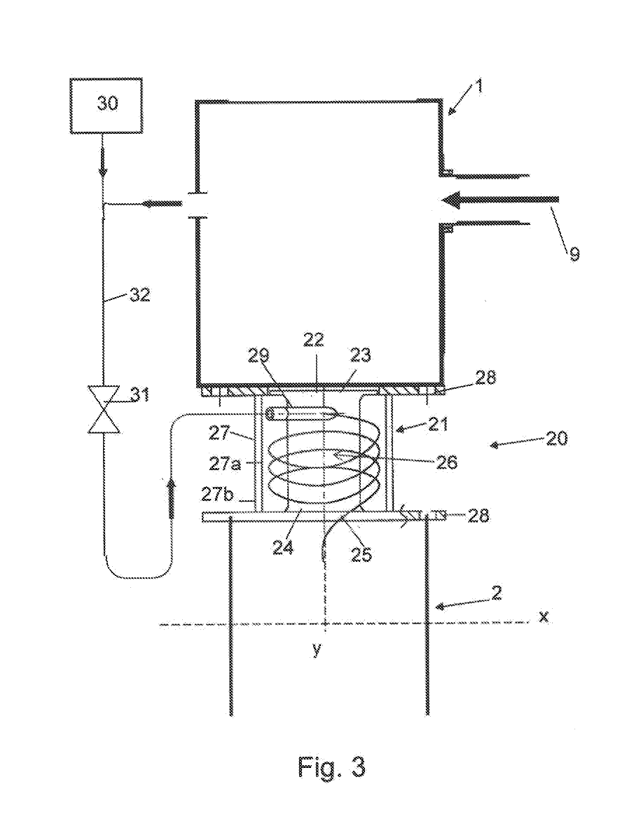

FIG. 3 shows a purge air cyclone 20 according to the present invention. The purge air cyclone 20 is configured to be provided on a low frequency sound generator as described above. Preferably, the purge air cyclone 20 is provided between the feeder unit 1 and the resonator tube 2.

The purge air cyclone 20 comprises a short duct 21 having a circular cross section. The short duct 21 comprises a first end 22, which comprises a first opening 23 and a second end 24, which comprises a second opening 25. A cavity 26 is defined between the first end 22 and the second end 24. The first opening 23 is configured to be in open communication with the feeder unit 1. The second opening 25 is configured to be in open communication with the resonator tube 2. The open communications are such that air pulses generated by the feeder unit of the low frequency sound generator is allowed to pass through the first opening 23, the cavity 26 and the second opening 25 of the short duct 21.

The purge air cyclone 20 also allows for a back and forth movement of the gas inside the resonator to pass through the second opening 25, the cavity 26 and the first opening 23 of the short duct 21.

The short duct 21 comprises a wall 27 extending between the first end 22 and the second end 24. Said wall 27 is defined by an inner diameter 27a and an outer diameter 27b. The diameter of the inner wall 27a may be the same or larger than the diameter of the first opening 23 and/or the second opening 25.

The purge air cyclone 20 comprises an inlet pipe 29. The inlet pipe 29 extends tangentially into the cavity 26 with respect to the short duct 21. The inlet pipe 29 extends through the wall 27, whereby a first opening of the inlet pipe 29 is positioned on the surface of the inner wall 27a of the short duct 21. A second opening of the inlet pipe 29 may be positioned on the surface of the outer wall 27b. An air conducting pipe 32 may be used to connect the inlet pipe 29 to a compressed air supply system 30.

The inlet pipe 29 has a length that may extend along a substantially straight center line x that may be perpendicular to the center line of the short duct y. The first opening of the inlet pipe 29 on the surface of the inner wall 27a may also be positioned closer to the second end 24 of the short wall 21 than the second opening of the inlet pipe 29 on the surface of the outer wall 27b, such that compressed air from the inlet pipe 29 is blown downwards towards the second end 24 of the short duct upon entering the cavity 26. The inlet pipe 29 is preferably positioned in the proximity of the first end 22.

The inlet pipe 29 is connected to the compressed air supply system 30. A valve 31 may be used to regulate the purge air flow to the cavity 26. The compressed air supply system 30 may be the same or different as compressed air supply system 9, 14 of the low frequency sound generator.

The flow of purge air from the inlet pipe 29 is introduced into the cavity 26 in such a way that dust particles present in the cavity 26 can be removed. In one embodiment, the flow of purge air circulates in the cavity 26 before leaving the cavity 26 through the second opening 25. Preferably, the purge air circulates several times in the cavity 26 before leaving said cavity 26. The purge air flow from the inlet pipe 29 is suitably configured for the removal of 90 to 99,9% of the dust particles present in the cavity 26. The exact flow rate of the purge air from the inlet pipe 29 or the number of circulations of the purge air flow in the cavity 26 may depend on the size of the low frequency sound generator, the size of the short duct 21 or the amount of dust particles present in the cavity 26.

The flow of purge air introduced into the cavity 26 through the inlet pipe 29 does not, or substantially not affect the back and forth movement of the gas inside the resonator tube of the low frequency sound generator.

The purge air cyclone 20 has connection means (not shown) configured to connect the purge air cyclone 20 to the low frequency sound generator. The flanges 28 at the first end 22 and the second end 24 may comprise holes (not shown) to attach the purge air cyclone 20 to the low frequency sound generator.

Control means (not shown) may be provided to control the operation of the low frequency sound generator, the purge air flow from the inlet pipe 29, the regulation of the valves 15 and/or 31, etc. These control means may be manual means or automatic control means.

The expression “low frequency sound” as used herein is meant to include sound of a frequency below approximately 38 Hz. A suitable operating frequency would be between approximately 15 and 30 Hz.

The expression “dust particles” as used herein is meant to include soot or any other solid and/or liquid particles present in a gas.

The present invention is not limited to the embodiments disclosed but may be varied and modified within the scope of the following claims.

1. A purge air cyclone (20) configured to be provided on a low frequency sound generator, which comprises a compressed air supply unit (9, 14), a feeder unit (1) and a resonator tube (2), whereby the purge air cyclone (20) is configured to be positioned between the feeder unit (1) and the resonator tube (2), and comprises a cylinder (21) extending along a longitudinal axis (y) and having a circular cross section, and comprising a first end (22), which comprises a first opening (23), a second end (24), which comprises a second opening (25), and a cavity (26) defined between the first end (22) and the second end (24),
characterized in that
the first opening (23) is configured to be in open communication with the feeder unit (1) and the second opening (25) is configured to be in open communication with the resonance tube (2), and in that
an inlet pipe (29) is positioned in the proximity of the first end (22) and extends tangentially into the cavity (26) with respect to the longitudinal axis (y), thereby being configured to introduce a purge air flow into the cavity (26) so as to circulate in the cavity (26) before leaving the cavity (26) through the second opening (25).

2. The purge air cyclone (20) according to claim 1, whereby the inlet pipe (29) is connected to a compressed air supply system (30).

3. The purge air cyclone (20) according to any one of claim 1 or 2, whereby the inlet pipe (29) optionally comprises a valve (31) configured to regulate the purge air flow through the inlet pipe (29).

4. The purge air cyclone (20) according to any one of claims 1 to 3, whereby the compressed air supply unit (30) connected to the inlet pipe (29) is the compressed air supply unit (9, 14) comprised in the low frequency sound generator.

5. The purge air cyclone (20) according to any one of claims 1 to 4, whereby the cylinder (21) is configured to allow a back and forth movement of gas inside the resonator tube to pass through the first opening (23), the cavity (26) and the second opening (25) of the cylinder (21).

6. Use of a purge air cyclone (20) according to any one of claims 1 to 5 preventing dust particles to enter into the cylinder (5) of the feeder unit (1).

7. A low frequency sound generator, which comprises a compressed air supply unit (9, 14), a feeder unit (1) and a resonator tube (2), characterized in that
the low frequency sound generator further comprises a purge air cyclone (20) configured to be positioned between the feeder unit (1) and the resonator tube (2), which comprises a cylinder (21) extending along a longitudinal axis (y) and having a circular cross section, and comprising a first end (22), which comprises a first opening (23), a second end (24), which comprises a second opening (25), and a cavity (26) defined between the first end (22) and the second end (24),
whereby the first opening (23) is configured to be in open communication with the feeder unit (1) and the second opening (25) is configured to be in open communication with the resonator tube (2), and in that
an inlet pipe (29) is positioned in the proximity of the first end (22) and extends tangentially into the cavity (26) with respect to the longitudinal axis (y), thereby being configured to introduce a purge air flow into the cavity (26) so as to circulate in the cavity (26) before leaving the cavity (26) through the second opening (25).

8. The low frequency sound generator according to claim 7, whereby the inlet pipe (29) is connected to a compressed air supply unit (30), which optionally comprises a valve (31) configured to regulate the compressed air flow through the inlet pipe (29).

9. The low frequency sound generator according to any one of claim 7 or 8, whereby the compressed air supply unit (30) connected to the inlet pipe (29) is the compressed air supply unit (9, 14) comprised in the low frequency sound generator.

10. The low frequency sound generator according to any one of claims 7 to 9, whereby the cylinder (21) is configured to allow a back and forth movement of gas inside the resonator tube of the low frequency sound generator to pass through the first opening (23), the cavity (26) and the second opening (25) of the cylinder (21).

11. Use of the low frequency sound generator according to any one of claims 7 to 10 for cleaning a boiler or a heat exchanger.
